(19) United States
(12) Patent Application Publication
(10) Pub. No.: US 2011/0278526 A1
(43) Pub. Date: Nov. 17, 2011

(54) REUSABLE TEMPORARY SAFETY RAIL POST AND EXTENSION KIT

(76) Inventors: Joseph CARVALHO, Bradford (CA); Jose CARVALHO, Bradford (CA)

(21) Appl. No.: 13/112,134

(22) Filed: May 20, 2011

Related U.S. Application Data
(63) Continuation-in-part of application No. 12/241,170, filed on Sep. 30, 2008.

(30) Foreign Application Priority Data
Dec. 21, 2007 (CA) 2616389
May 21, 2010 (CA) 2704888

(51) Int. Cl. E04H 17/20; B23P 11/00; E04H 17/14

(52) U.S. Cl. 256/67; 256/65.03; 29/428

(57) ABSTRACT

There is described a reusable temporary safety rail post for a safety fence for bordering an elevated work area. The post includes a stanchion member, the lower end of which is attached to a horizontal plate. The upper portion of the stanchion member has one or more brackets for supporting horizontal safety rails which extend between adjacent post assemblies. A receiving bracket connected to the floor of the work area receives the horizontal plate and holds the stanchion in a vertically upright position. Also described is an extension kit by which the height of the post can be temporarily increased. The extension kit includes a vertical extension member having additional angular railing brackets, which is removably attached to the upper end of the stanchion so as to extend its height. The extension kit also includes a support bracket which provides additional support to the vertically extended post.

### FIELD OF THE INVENTION

The present invention relates to a reusable temporary safety rail post. Specifically, the present safety rail post is an apparatus for constructing safety fences for containing elevated work areas during residential or commercial construction. The post can be installed temporarily with minimal effort and is reusable on multiple construction projects.

### BACKGROUND OF THE INVENTION

It is commonplace, and required by law in many jurisdictions, to construct a temporary safety fence around raised work areas. This provides fall protection for workers working above the ground. Occasionally, workers construct temporary railings made of lumber found around a typical construction site. However these temporary wooden railings lack strength, are susceptible to weathering, waste valuable lumber and are not based on a single proven design to ensure safety.

The prior art describes a number of solutions to address this problem.

U.S. Pat. No. 6,908,075 to Nichols discloses a safety rail system designed for residential housing constructions having cantilevered second stories. The Nichols safety rail is cantilevered away from the first floor walls to allow for the overhanging second story, and once the separate rail posts are linked together using rails constructed from dimensional lumber, the elevated work area is contained. However, the Nichols safety rail attaches to the first floor studs by means of wood screws in a semi-permanent manner and cannot be easily removed once the cantilevered second story floor is installed. This results in the Nichols safety rail being difficult to remove once the second story is complete and the safety rail is no longer necessary.

U.S. Pat. No. 5,314,167 to Holloman discloses a temporary rail structure designed to attach to the floor joist header of the second story. This temporary rail utilizes common lumber to construct the railings as in Nichols and attaches via a U shaped yoke that clamps tightly to the outer floor joist header. Linking multiple Holloman posts together with lumber rails of typical lumber results in a safety rail that contains the work area, however the aforementioned U shaped yoke does not allow plywood subflooring to be installed while the rail is in place. Therefore, the Holloman rail must be removed when the subflooring is installed, which typically occurs at a time when the safety rails are still required, as the second floor walls have not been completed.

U.S. Pat. No. 4,666,131 to Kettelcamp, Sr. et al. discloses an adjustable guard rail stanchion which clamps to the underside of a roofing truss. The Kettelcamp guard rail stanchion is easily installed and removed, however it is particularly designed for a roofing application and cannot be readily modified for the needs of second story work area containment.

Accordingly, there is a need for a safety rail post that is quick and easy to install and remove, reusable, strong and adaptable to different types of residential house constructions.

### SUMMARY OF THE INVENTION

The present invention overcomes the deficiencies of the prior art by providing a safety rail post that can be easily installed during construction and quickly removed after the safety rail is no longer necessary. It does so without limiting access to the work structure while providing an effective safeguard against an inadvertent fall by a worker.

The reusable temporary safety post is comprised of an upright stanchion with a bottom bracket arrangement. During use, the safety rail posts are installed on the work structure, the method of doing so varying depending on the type of construction employed, as discussed below. Once installed in place, the separate reusable safety posts can be linked together using rails consisting of typical construction lumber, which fit into angular railing brackets provided on the upright stanchions. The rails are easily secured in place using nails or wood screws inserted through a hole provided in the angular railing brackets.

In the case of a typical two story house construction, the reusable safety posts are secured to the work structure according to a first aspect of the invention. Specifically, a slotted female plate is secured near the top of the first story wall sheathing on the outside. This slotted female plate mates with an insertable male plate located near the bottom of the upright stanchion. Each post is additionally further secured to the lower wall structure by means of a lower support plate located at the bottom of the upright stanchion. Two by four safety rails may then be installed to span the gaps between adjacent posts. Removal consists of the preceding steps carried out in reverse order.

Another aspect of the present invention, which involves a reusable temporary safety rail post with a cantilevering bottom bracket, is used in applications where the structure's second story is cantilevered out from the first story. In this arrangement, the cantilevered bottom bracket is designed with an inverted U-shaped yoke that fits over the header of the first floor wall. The cantilevered design extends the reusable safety post away from first floor wall such that it does not interfere in the construction of the overhanging second story floor. The two by four rails are installed between adjacent posts in the same manner as described above. Removal is accomplished by simply removing the rails and “unhooking” the safety posts from the top of the first story wall.

In yet a further aspect of the present invention, the reusable temporary safety rail posts are secured to the floor of the work structure. In at least one embodiment, a slotted female plate is secured to the floor and an insertable male plate at the end of the upright stanchion mates with the female plate. Installation of the rails is achieved in the manner described above. The posts are readily removed by removing the rails and sliding the male plate of the stanchion out of the slots in the female floor plate.

Another aspect of the present invention provides an extension kit by which the height of the temporary safety rail posts can be temporarily increased, for example, when a taller safety enclosure is desired. The extension kit includes a vertical extension member having additional angular railing brackets, which is removably attached to the upper end of the stanchion so as to extend its height. The extension kit also includes a support bracket which provides additional support to the vertically extended post.

### BRIEF DESCRIPTION OF THE DRAWINGS

Preferred embodiments of the present invention will now be described in greater detail and will be better understood when read in conjunction with the following drawings in which:

FIG. 1 is a perspective view of the reusable temporary safety rail post adapted for use in typical two story residential house construction;

FIG. 2 is an exploded view of the mating male and female plates of FIG. 1;

FIG. 3 is a perspective view of the safety rail post in an installed position;

FIG. 4 is a perspective view of a plurality of safety rail posts pre-installed on a wall section which is then rotated into an upright position;

FIG. 5 is a perspective view of the safety rail posts forming a fence around a completed first story;

FIG. 6 is a perspective view of a modified temporary safety rail post;

FIG. 7 is a perspective view of a reusable temporary safety rail post adapted for a two story residential house construction incorporating a cantilevered second floor;

FIG. 8 is a front perspective view of the safety rail post of FIG. 7 in an installed position;

FIG. 9 is a rear perspective view of the safety rail post shown in FIG. 8; and

FIG. 10 is a perspective view of the safety rail posts of FIG. 7 forming a fence around the cantilevered floor of a second story.

FIG. 11 is an exploded view of a reusable temporary safety rail post and receiving bracket, adapted for mounting on a floor.

FIG. 12 is a front perspective view of the receiving bracket of FIG. 11.

FIG. 13 is a rear perspective view of the receiving bracket of FIG. 11 to which the safety rail post has been mounted.

FIG. 14 is a perspective view of the safety rail posts of FIG. 11 forming a safety fence along the edge of a staircase and elevated platform.

FIG. 15 is a perspective view of a vertical extension post for use with the present reusable temporary safety rail post.

FIG. 16 is a perspective view of a vertically extended safety rail post.

FIG. 17 is a perspective view of a support bracket for the vertically extended safety rail post of FIG. 16.

FIG. 18 is a perspective view of the vertically extended safety rail post of FIG. 16 forming a section of safety fence.

### DETAILED DESCRIPTION OF THE PREFERRED EMBODIMENTS

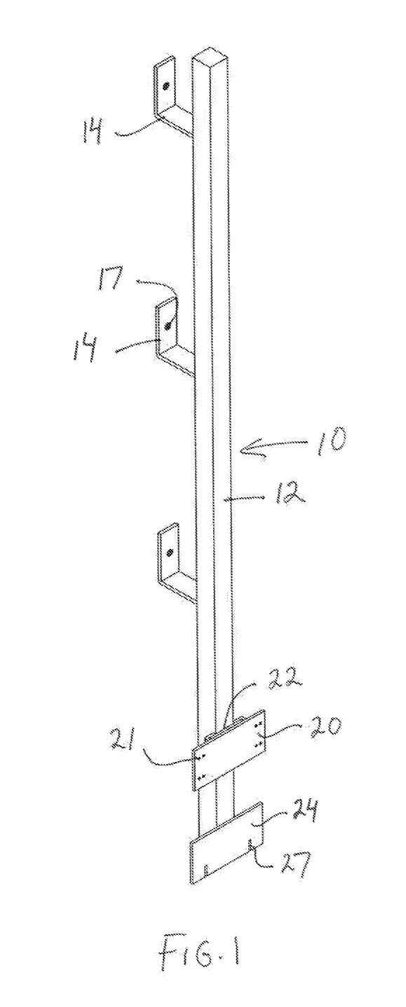

With reference to FIG. 1, showing the safety rail post used for non-cantilevered constructions, the present invention consists of reusable temporary safety post 10 which is comprised of an upright stanchion 12, a number of angular railing brackets 14, and a bottom bracket assembly 30 which is used to connect the safety posts to the upper edge of the first story wall as will be described below. These components may be manufactured from metal, with aluminum and galvanized or stainless steel being preferred.

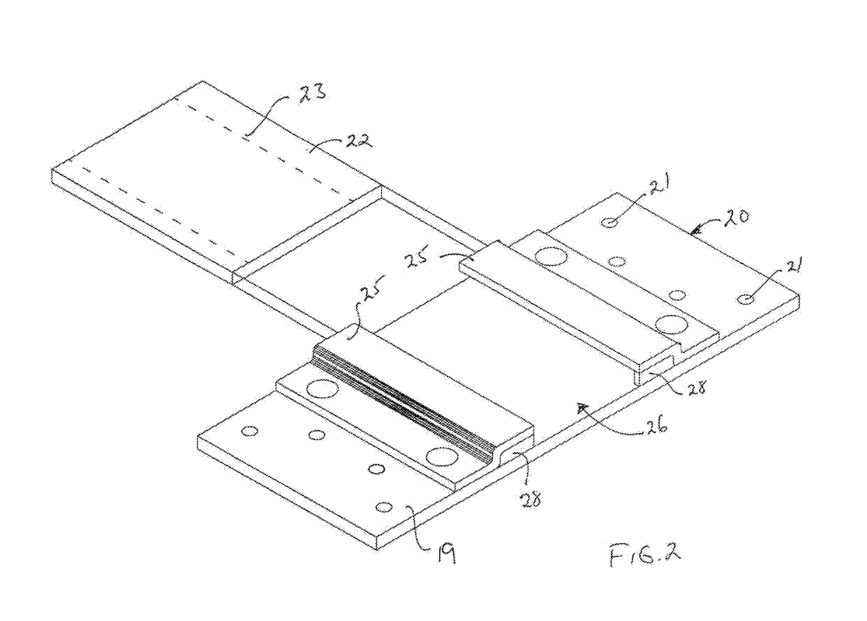

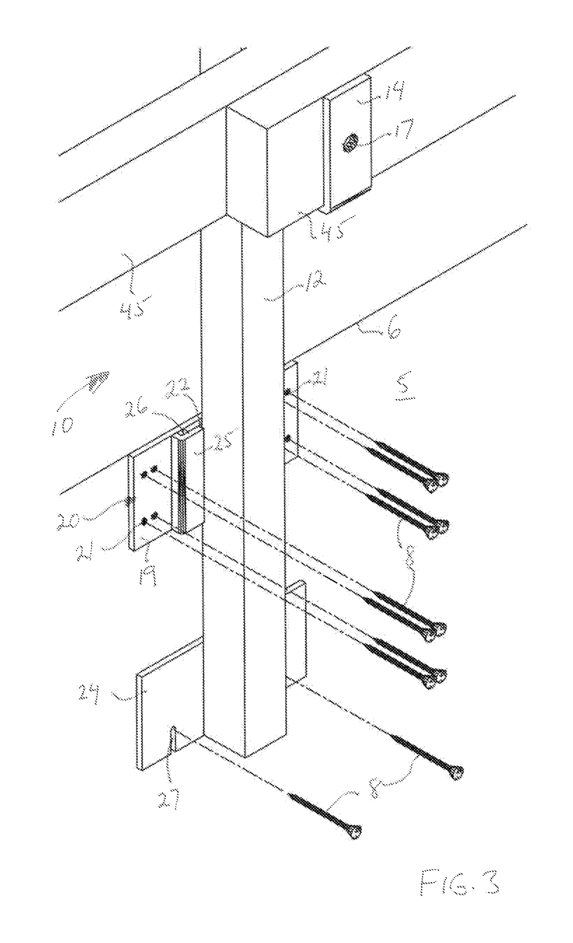

With reference to FIGS. 2 and 3, bottom bracket assembly 30 consists of first and second plates 22 and 24 strongly connected to stanchion 12, such as by means of permanent welds, and a bracket 20, which slidingly connects with first plate 22, and which itself is securely connected as shown in FIG. 3 to the upper edge 6 of first story wall 5.

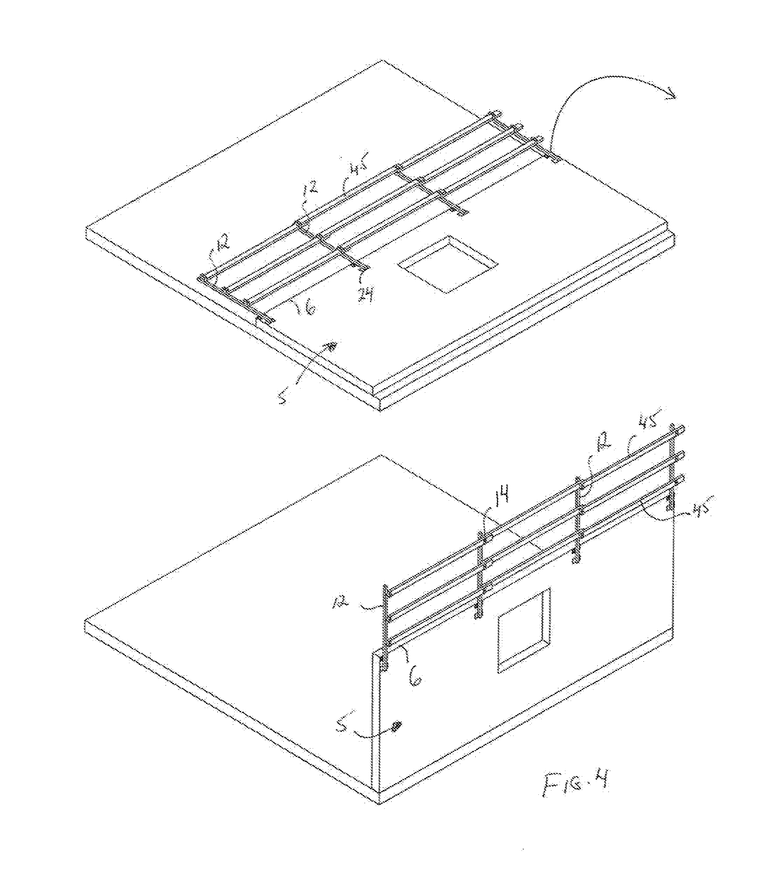

In the case of a typical two story residential housing construction where there is no overhang of the second story floor over the first floor walls, post 10 is installed as follows. Referring to FIGS. 2 and 3, bracket 20 is fastened to wall 5 using wood screws or nails 8 inserted through pre-drilled holes 21 in the bracket's base plate 19 into the wall's exterior sheathing or the wall studs behind the sheathing. This can occur before or after the first floor wall has been erected, but preferably occurs as the completed wall structure is lying flat on the ground floor as shown in FIG. 4 for easy access.

Once bracket 20 is installed post 10 can be installed. This is achieved by sliding first plate 22 into bracket 20 previously mounted onto wall 5. As can be seen best in FIG. 2, bracket 20 includes a pair of opposed flanges 25 welded onto base plate 19 to define a slot 26 between them sized to slidingly receive plate 22. The lower ends 28 of slot 26 inside the flanges can be closed or stoppered for example by depositing a bead of excess welding material or by any other means known in the art. This controls the degree of insertion of plate 22 into slot 26. The dashed weld lines 23 indicate where first plate 22 is welded to upright stanchion 12 (not shown in FIG. 2).

Once safety post 10 is installed into bracket 20, it is then additionally secured by fastening lower support plate 24 to wall 5 using nails or wood screws 8 inserted through slots 27 formed or cut into the lower edge of plate 24. Lower support plate 24 provides enhanced stability to the entire assembly, and is located at the lower end stanchion 12 on the same side as plate 22. Once all the support posts 10 are connected, wall 5 can be rotated onto its upright position as shown in FIG. 4.

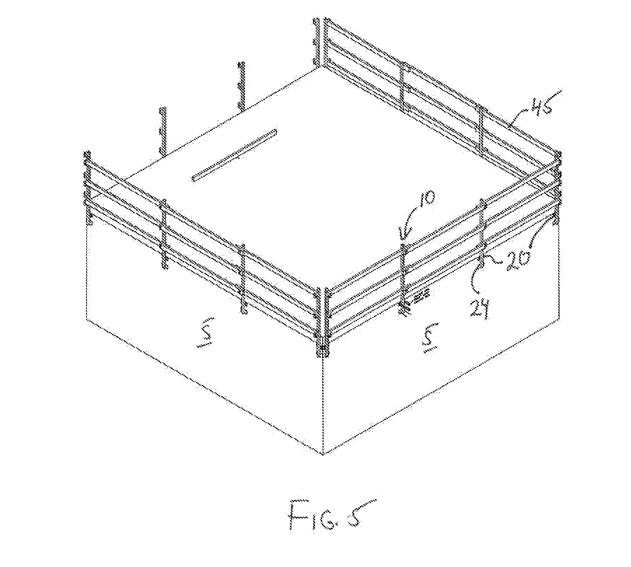

With posts 10 in place, safety rails 45, typically two by fours, can be installed with the length of the rails determined by the requirements of the particular application as shown in FIG. 5. The safety rails can be installed before or after wall 5 is rotated into its upright position, but for ease of installation, and for safety reasons, the rails are preferably installed before the wall is moved upright. Ideally, angular railing brackets 14 are sized to receive two rails placed side by side and secured by a nail or wood screw inserted through a hole 17 provided in each bracket. In one embodiment of the invention, each post 10 may have three railing brackets 14.

Removal of posts 10 is accomplished by removing rails 45 and then pulling posts 10 upwardly to disengage plate 22 from bracket 20. Plate 24 will simultaneously slide past nails or screws 8 in slots 27. Brackets 20 and fasteners 8 can be removed later or left in place to be covered by brick or siding.

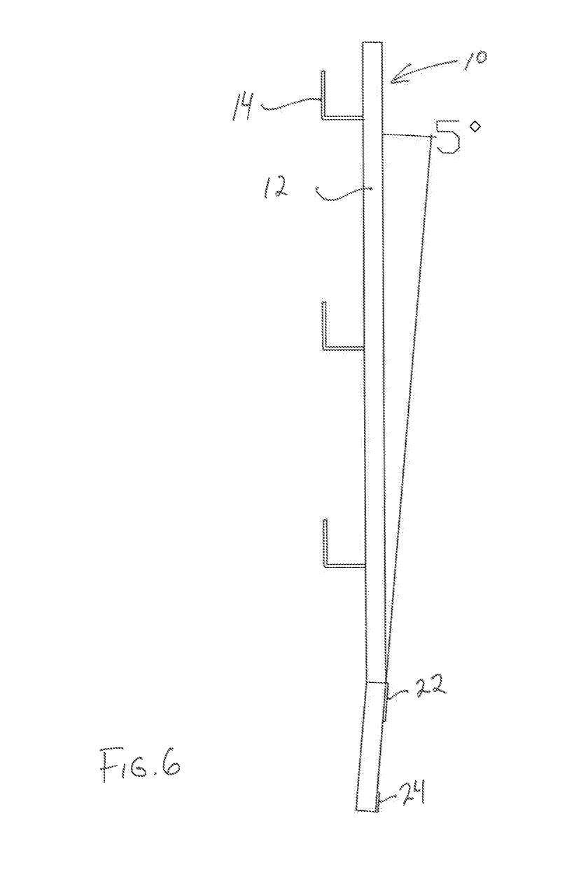

Reference will now be made to FIG. 6 showing a modified safety rail post 10 wherein like numerals have been used to identify like elements. In this embodiment, stanchion 12 is formed with a small dog leg bend of about 5 degrees. The angle of the bend can be bigger or smaller as required. The bend can be formed by actually bending the stanchion by the desired amount or welding two pieces of stanchion together at the desired angle. The bend slopes the portion of the stanchion above the bend away from the work area to provide additional clearance for installation of the rim joists that surround the second story floor joists.

In one embodiment constructed by the applicant, the stanchions are 1.5″ square, plate 22 is 2½″ wide by 3″ high, plate 24 is 6″ wide by 1½″ to 3″ high, bracket 20 is 7″ wide by 3″ high. These pieces are preferably made from 3/16″ thick steel plate.

In another application, the present invention may be modified for use in housing construction in which cantilevered second stories are employed. This occurs for example when a second story floor extends out past the first floor walls in order to accommodate a brick fascia on the outside of the first floor with vinyl or aluminum siding or a similar cladding on the second floor.

In this embodiment of the present invention, the reusable temporary safety post has a bottom bracket arrangement adapted to fit over the upper edge or header of the first floor wall.

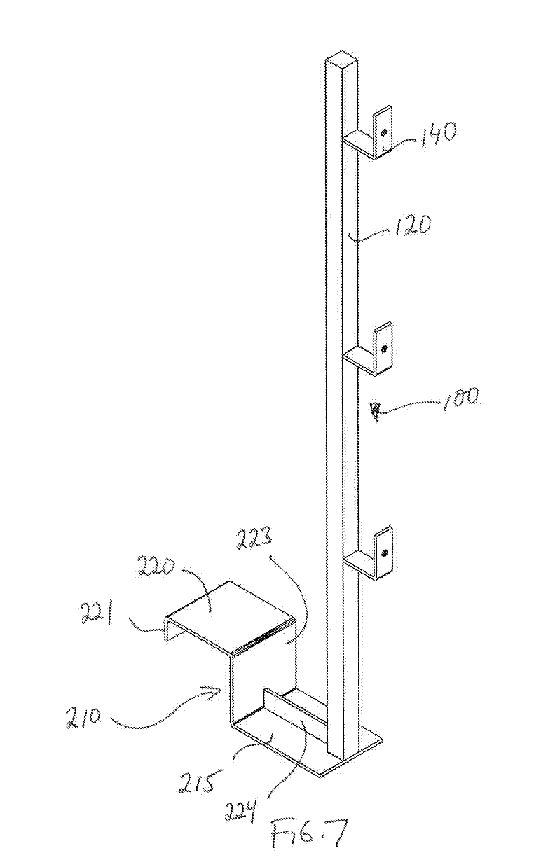

Reference will now be made to FIG. 7 showing a safety post 100 modified for this particular application.

As will be seen post 100 includes a stanchion 120 and one or more rail brackets 140. The stanchion and brackets are substantially the same as described above with respect to the embodiment of FIGS. 1 to 5. In this embodiment however, plates 22 and 24 and bracket 20 are replaced by a cantilevering yoke 210.

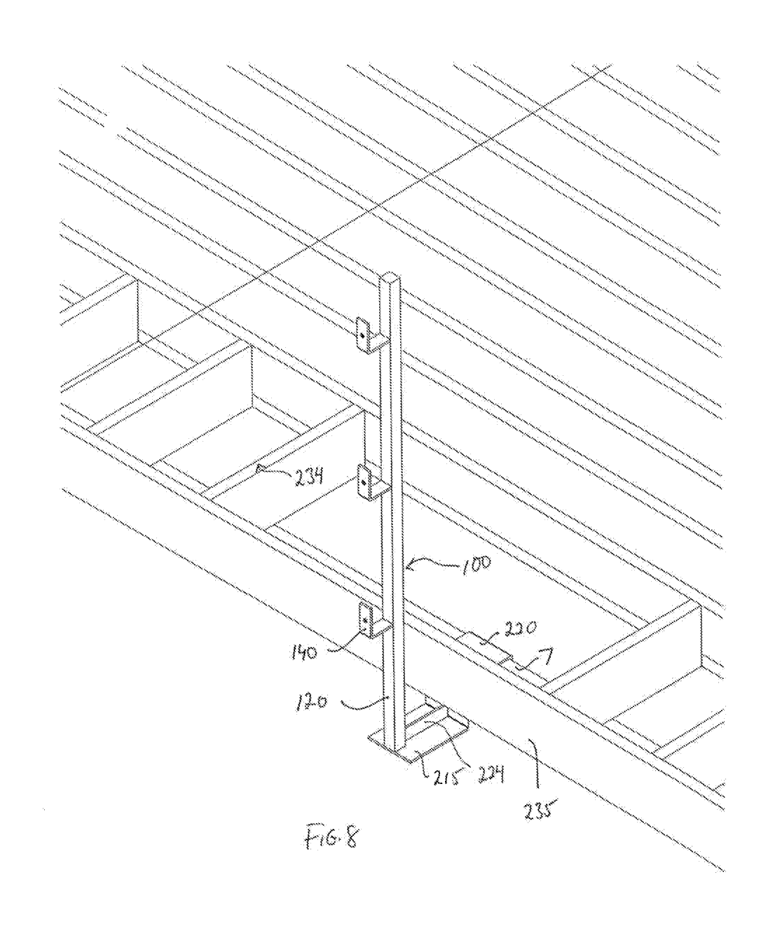

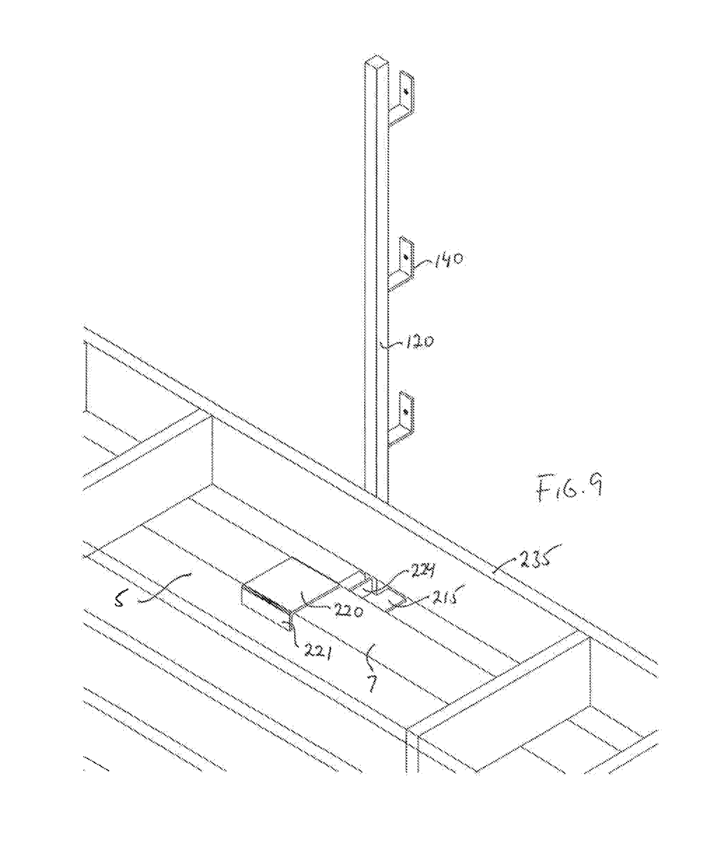

Yoke 210 consists of a horizontal plate 215 that stanchion 120 is welded to and an inverted U-shaped bracket 220 that is sized to closely fit over the header 7 of lower wall 5 as shown most clearly in FIGS. 8 and 9. Added between stanchion 120 and bracket 220 is a stiffening rib 224 that prevents plate 215 from flexing when a load is applied to the safety rails. The stiffening rib is strongly connected to the yoke such as by welding. The use of rib 224 is but one example of a means to reinforce plate 215 against flexing. Numerous others will occur to those skilled in the art.

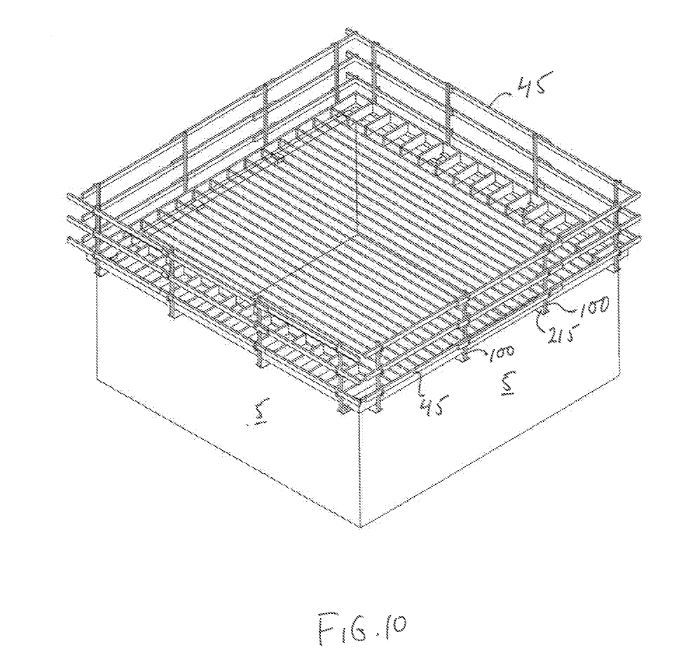

Installation can occur before or after the second story floor 234 is installed, but necessarily after the first floor walls have been erected. Bracket 220 is fitted over header 7 of first floor wall 5. If the second story floor is already installed, posts 100 must necessarily be installed between the second story floor joists. When installed, plate 215 and stiffening rib 224 pass beneath the fascia or rim joist 235 of second story floor 234. Plate 215 is long enough that stanchion 120 easily clears the fascia preferably by at least 2″. Since plate 215 passes beneath the fascia, it does not interfere in the installation of plywood or underlay to the upper surface of the second story floor, nor in the erection of the second story walls. Once the posts 100 are installed, safety rails 415 are installed in the same manner described above to form a fence around the second story floor as shown in FIG. 10.

As mentioned above, stiffening rib 224 prevents horizontal plate 215 from flexing when loaded. This prevents torque applied to the stanchions from inadvertently disengaging bracket 220 from header 7. As an additional safety measure, the two opposing vertical sides 221 and 223 of bracket 220 have minimum vertical dimensions depending on the closeness of the fit of the bracket over header 7.

In one embodiment constructed by the applicant, yoke 210 is constructed from 3/16″ steel plate. Bracket 220 is sized to fit over header 7 with 1/16″ of clearance. Vertical side 221 is 2″ high and side 223 is 6″ high. Plate 215 extends outwardly from the lower edge of side 223 approximately 8½″.

Although fasteners can be driven through bracket 220 into header 7, this is not preferred due to the added effort and difficulty of removing the fasteners once the second story floor is installed.

Removal of posts 100 is accomplished by disassembling the safety rails, and removing brackets 210 by rocking and sliding them off headers 7.

In yet another application, the present reusable temporary safety post can be adapted for mounting directly on a floor. Such an application is useful, for example, when an elevated work area includes staircases or cantilevered elevated platforms, where no convenient supporting walls are located directly underneath.

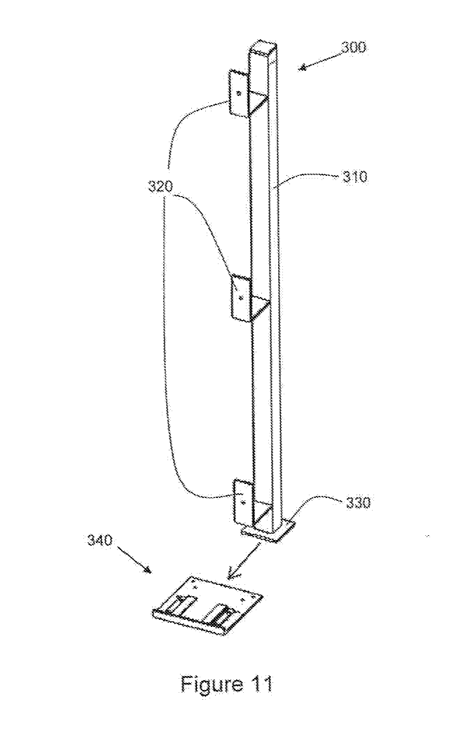

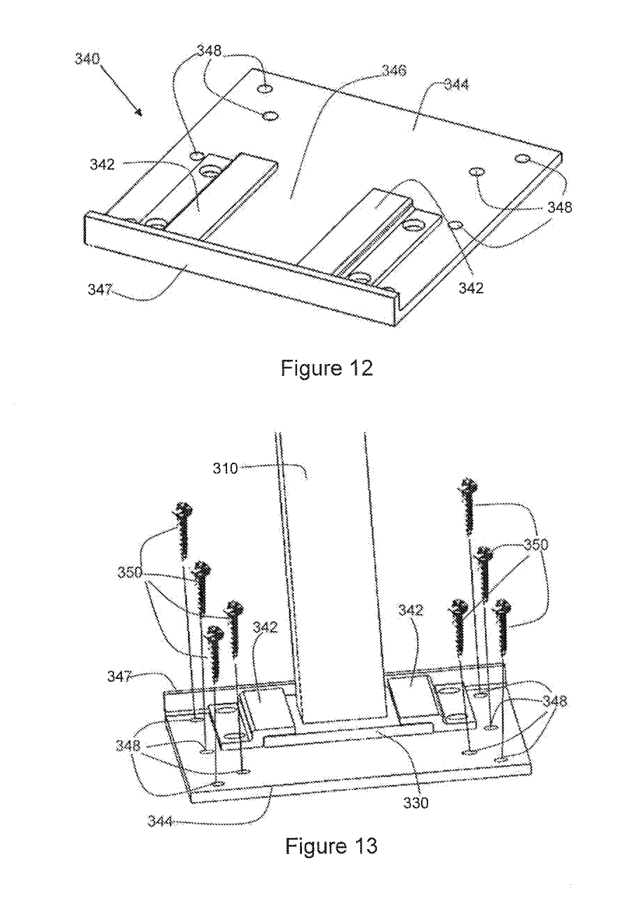

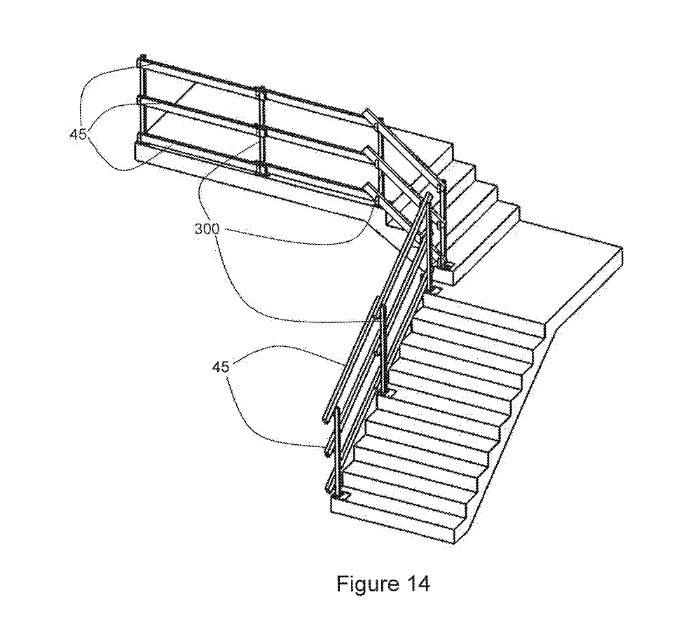

An embodiment of the present safety post adapted for mounting directly on a floor is illustrated in FIG. 11. Post 300 includes stanchion 310 and one or more railing brackets 320, which are substantially the same as the stanchions and railing brackets described above. Lower plate 330, which may be made from metal, such as aluminum, galvanized steel, or stainless steel, is securely attached to the end of stanchion 310 by means well known in the art, including welding. Lower plate 330 is adapted to be slidingly received by a receiving bracket 340, as indicated by the arrow in FIG. 11. Receiving bracket 340, shown in further detail in FIGS. 12 and 13, includes a pair of opposed flanges 342 welded onto base plate 344 to define a slot 346 between them sized to slidingly receive lower plate 330, as seen in FIG. 13. Stop 347 acts to control the degree of insertion of lower plate 330 in slot 346. Receiving bracket 340 is attached to the floor by means of fasteners 350, such as nails or screws, inserted through pre-drilled holes 348 in base plate 344. Once receiving brackets 340 and posts 300 are installed, safety rails 45 can be installed as previously described, to provide a safety fence for application on staircases or elevated platforms, as seen in FIG. 14. Removal of posts 300 is accomplished by removing rails 45 and sliding posts 300 horizontally out of slots 346 in receiving brackets 340. Receiving brackets 340 can then be removed from the floor surface by removing fasteners 350.

The reusable temporary safety posts of the present invention can also be vertically extended for application where higher safety fences are required. As one example, local regulations may require that such higher safety fences be installed bordering elevated work areas where workers wearing stilts are working.

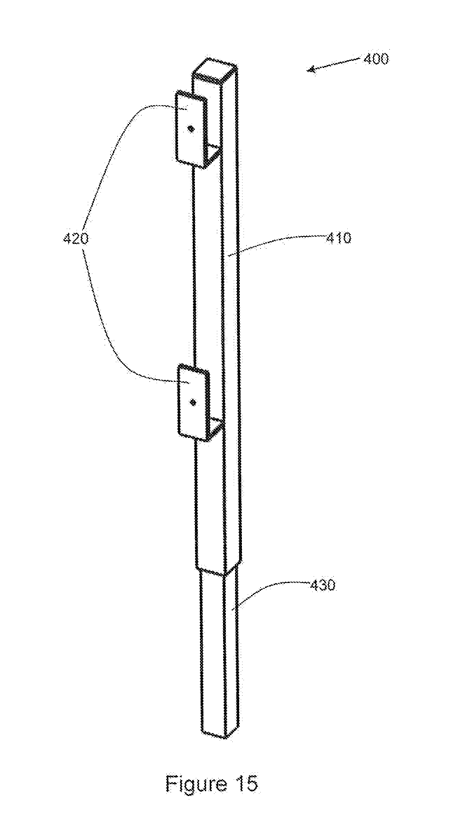

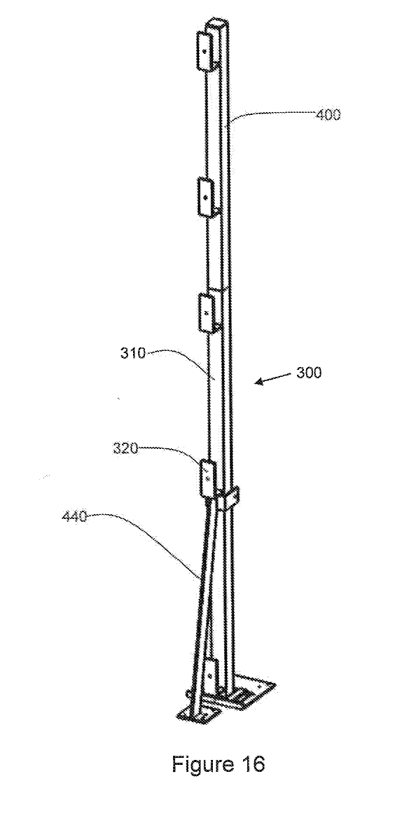

FIG. 15 illustrates a vertical extension post 400 for use with the present posts. Vertical extension post 400 includes stanchion extension 410 and one or more railing brackets 420, which are substantially the same as the railing brackets previously described herein. Stanchion extension 410 is similar in shape and composition to stanchions previously described, but has a lower extension 430 sized to be telescopically received within the open end of a stanchion such as, for example, stanchion 310, so as to extend the height of the post, as shown in FIG. 16.

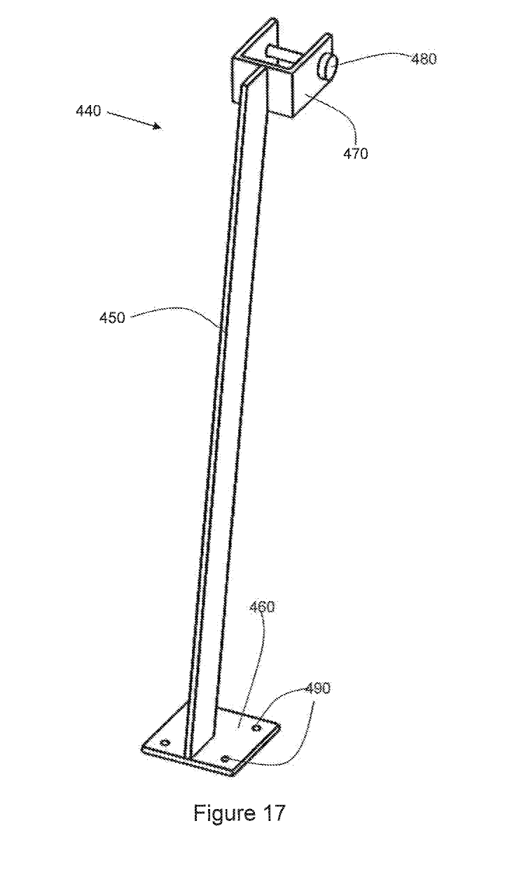

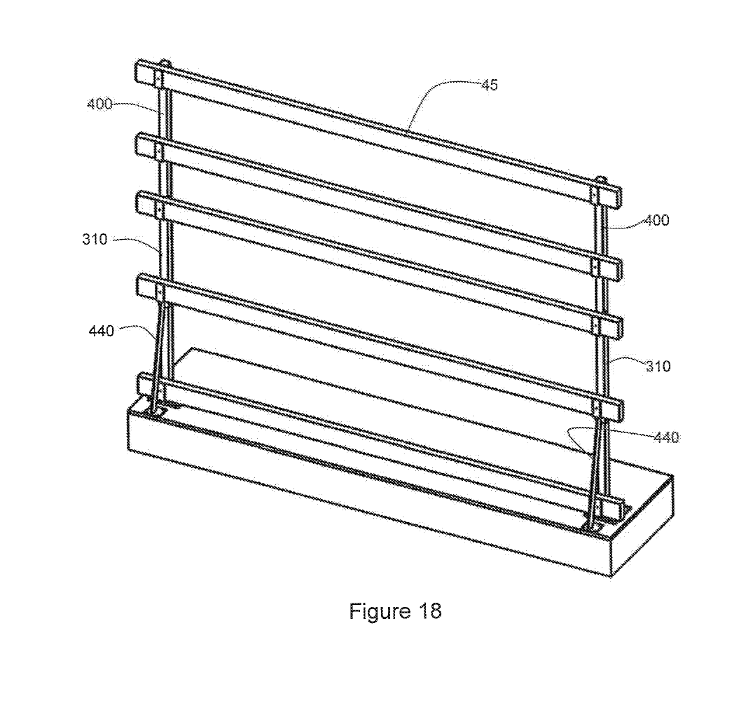

When a post has been extended in height using a vertical extension post, a support bracket 440 may also be used to provide extra support, as shown in FIG. 16. Support bracket 440 is illustrated in further detail in FIG. 17, and can be made of metal, for example. Support arm 450 is connected, for example by welding, to a floorplate 460 at one end, and to a collar 470 at the other end. Collar 470 is sized to surround a stanchion according to the present invention, for example stanchion 310, as shown in FIG. 16, and is secured around the stanchion by the use of a removable and securable pin or bolt 480 spanning the open end of the collar 470. Support arm 450 is attached to floorplate 460 at an angle which allows the support bracket 440 to be attached to the floor while collar 470 is positioned to engage and surround the stanchion of an adjacent post and abut against the underside of a railing bracket 320 such as the middle railing bracket 320 in FIG. 16. Such an angle will be readily determinable by one of skill in the art. The abutment of collar 470 against the underside of railing bracket 320 prevents upward movement of the collar relative to stanchion 310 to resist torque applied to the safety fence from within the work area. Floorplate 460 is fastened to the floor by the use of fasteners, such as nails or wood screws, inserted through pre-drilled holes 490, at a position adjacent to the position where the post is fixed to the work surface. In at least one embodiment, the support bracket is located so as to engage the post on the side thereof bearing the railing brackets, as shown in FIGS. 16 and 18. In this way, the support bracket is positioned outside of the work area, so as not to interfere with workers working inside the area, and so as to provide extra support to a safety fence if a worker should fall against the safety fence from inside the work area.

An existing safety fence using posts and rails according to the present invention can readily be extended in height by means of a vertical extension kit containing vertical extension posts and support brackets described above. The safety fence is constructed from posts 300 and rails 45 as described above, then vertical extension posts 400 and support brackets 440 are installed as described above and as shown in FIG. 18. Rails 45 are installed on the vertical extension posts 400, in the same manner as described previously for installing rails on the posts, to increase the height of the safety fence. Removal of the fence is readily accomplished by removing the rails 45 and sliding the vertical extension posts 400 out of the upper end of the stanchions 310. The support brackets 440 are disengaged from the stanchions 310 by removing pin or bolt 480, allowing the stanchion 310 to be removed from collar 470 so that the posts can be dismantled as described previously. The support brackets 440 can then be removed from the floor by removing the fasteners from the pre-drilled holes 490.

The above-described embodiments of the present invention are meant to be illustrative of preferred embodiments and are not intended to limit the scope of the present invention. Various modifications, which would be readily apparent to one skilled in the art, are intended to be within the scope of the present invention. The only limitations to the scope of the present invention are set forth in the following claims appended hereto.

1. A post assembly for a safety fence for bordering an elevated work area, the work area including a wall section supporting an elevated floor section to be bordered by the safety fence, said post assembly comprising:
a stanchion member having upper and lower sections, said lower section having a first upper and a second lower plate fixedly connected thereto, said first and second plates being vertically spaced apart by a pre-determined distance, said upper portion having one or more brackets connected thereto for supporting horizontal safety rails which extend between adjacent post assemblies; and
a third plate connectable to the wall section at a selected location, said third plate including means for a torque-resistant connection to said first plate to hold said stanchion in a vertically upright position relative to the wall section;
wherein said second plate is connectable to the wall section when said first plate is connected to said third plate, thereby securing said stanchion to the wall section.

2. The assembly of claim 1 wherein said third plate is formed with a slot to slidably receive said first plate thereinto.

3. The assembly of claim 2 wherein said slot is vertically aligned so that said first plate slides vertically into said slot to connect said stanchion to said third plate and slides vertically out of said slot to disconnect said stanchion from said third plate.

4. The assembly of claim 1 wherein said third plate is connectable to the wall section by means of fasteners.

5. The assembly of claim 4 wherein said second plate is connectable to the wall section by means of fasteners.

6. The assembly of claim 5 wherein a lower edge of said second plate includes one or more vertically extending slots formed therein.

7. The assembly of claim 6 wherein said fasteners connecting said second plate to the wall section extend through said one or more vertically extending slots.

8. The assembly of claim 7 wherein said stanchion can be disconnected from the wall portion by lifting it vertically to withdraw said first plate from said slot in said third plate and to pull said second plate past said fasteners inserted through said one or more vertical slots.

9. The assembly of claim 8 wherein said third plate includes a plurality of holes preformed therein for the insertion of fasteners to connect said third plate to the wall portion.

10. The assembly of claim 1 wherein said stanchion includes a bend between said upper and lower sections so that said upper section slopes away from said elevated work area.

11. The assembly of claim 10 wherein said bend is about five degrees.

12. A method for connecting a safety fence around an elevated work surface supported by an underlying wall section, the method comprising the steps of:
fixedly connecting first and second vertically spaced apart plate members to a lower section of a stanchion member;
fixedly connecting a third plate member adjacent an upper edge of the wall section, the third plate member being adapted for a temporary, load bearing connection to the first plate on said stanchion;
connecting said first and third plates together, whereby said second plate is automatically positioned in opposed relation to the wall section for connection thereto, said first, second and third plate members cooperating to secure said stanchion in a vertically upright position relative to the wall section to provide a torque resistant connection between the stanchion and the wall section.

13. The method of claim 12 wherein the second plate is vertically slidable into and out of slot means formed in said third plate for connecting and disconnecting the stanchion to the wall section.

14. A post assembly for a safety fence for bordering an elevated work area, the work area including wall portions supporting an elevated outwardly cantilevered floor portion to be bordered by the safety fence, the wall portion including vertical studs topped by a header and the floor portion including horizontal joists surrounded by a fascia; the post assembly comprising:
a stanchion member having an upper portion and a lower end, said upper portion including one or more brackets thereon to support horizontal safety rails which extend between adjacent post assemblies; and
a yoke member connected to said lower end of said stanchion, said yoke member connecting said stanchion to the header of the wall portion to be in horizontally spaced apart relation to the fascia of the floor portion.

15. The assembly of claim 14 wherein said yoke member comprises a bracket portion shaped to fit over the header of the wall portion and a plate member connected to extend horizontally outwardly from the bracket portion to pass beneath the fascia of the floor portion.

16. The assembly of claim 15 wherein said stanchion is fixedly connected adjacent an outer edge of said plate member to extend vertically upright relative to the wall portion and to be horizontally spaced apart from the fascia of the floor portion.

17. The assembly of claim 16 wherein said bracket portion is an inverted U-shape to closely fit over and engage the header of the wall portion.

18. The assembly of claim 17 wherein said bracket portion includes an upper surface and two downwardly depending side surfaces that define said inverted U-shape, the height of said side surfaces being selected to prevent separation of said bracket portion from the header when a load is applied to said stanchion.

19. The assembly of claim 18 wherein said plate member is resiliently flexible whereby outwardly acting torque applied to said stanchion causes the plate member to flex downwardly relative to said bracket portion.

20. The assembly of claim 15 wherein said plate member is reinforced against flexing when loaded.

21. The assembly of claim 20 wherein said plate member is reinforced with a stiffening rib fixedly connected thereto.

22. A post assembly for a safety fence for bordering an elevated work area, the work area including an elevated floor section to be bordered by the safety fence, the post assembly comprising:
a stanchion member having an upper portion and a lower end, the lower end having a lower plate fixedly connected thereto, such that the lower plate is oriented in a horizontal plane when the stanchion member is oriented in a vertically upright position; and the upper portion having one or more brackets connected thereto for supporting horizontal safety rails which extend between adjacent post assemblies; and
a receiving bracket connectable to the floor section at a selected location, said receiving bracket including a connector adapted for torque-resistant connection to the lower plate to hold the stanchion in a vertically upright position relative to the floor section.

23. The assembly of claim 22 wherein the receiving bracket comprises at least one horizontal slot adapted to slidably receive the lower plate.

24. The assembly of claim 22 further comprising a vertical extension member having one or more brackets connected thereto for supporting horizontal safety rails which extend between adjacent post assemblies; wherein the upper portion of the stanchion member is adapted to engage the vertical extension member in mutual rectilinear alignment.

25. The assembly of claim 24 wherein the vertical extension member comprises a rectilinear projection and the upper portion of the stanchion member is adapted to telescopically receive the projection.

26. The assembly of claim 24 further comprising a support bracket, the support bracket comprising an arm having a first end and a second end; the first end adapted for secure connection to the floor section at a location adjacent to the receiving bracket; and the second end adapted for removably securing the upper portion of the stanchion member.

27. The assembly of claim 26 wherein the first end comprises a plate securely connectable to the floor section and the second end comprises a collar adapted to removably surround the upper portion of the stanchion member.

28. A vertical extension kit for a post assembly for a safety fence for bordering an elevated work area, the work area including an elevated floor section to be bordered by the safety fence, said post assembly having a stanchion member having an upper portion having one or more brackets connected thereto for supporting horizontal safety rails which extend between adjacent post assemblies; the stanchion member adapted to be securely fixed to the work area at a selected location; the vertical extension kit comprising:
a support bracket, the support bracket comprising an arm having a first end and a second end; the first end adapted for secure connection to the work area at a location adjacent to the location of the stanchion member; and the second end adapted for removably securing the upper portion of the stanchion member; and
a vertical extension member having one or more brackets connected thereto for supporting horizontal safety rails which extend between adjacent post assemblies; wherein the upper portion of the stanchion member is adapted to engage the vertical extension member in mutual rectilinear alignment.
